(19) United States
(12) Patent Application Publication
(10) Pub. No.: US 2007/0251104 A1
(43) Pub. Date: Nov. 1, 2007

(54) Electrical hand-held saw with suction device

(76) Inventors: Viktor Heinrichs, Untermeitingen (DE); Gunter Haas, Kaufering (DE)

Correspondence Address: ABELMAN, FRAYNE & SCHWAB, 666 THIRD AVENUE, 10TH FLOOR, NEW YORK, NY, 10017, US

(21) Appl. No.: 11/796,718

(22) Filed: Apr. 26, 2007

(30) Foreign Application Priority Data
Apr. 27, 2006 (DE) 10 2006 000 200.8

(51) Int. Cl. B23D 49/00; B25D 9/00

(52) U.S. Cl. 30/392; 173/114

(57) ABSTRACT

An electrical hand-held saw includes a saw blade (14) projecting from an end side (6) of the saw housing (4) and reciprocating along a stroke direction (H) that substantially extends in a direction of a longitudinal extent of the housing (4) limited by the end side (6), and a suction device (16) securable on the housing (4) and having a bearing region (22) adjoining the end side (6) of the housing (4) and a suction opening (54) for removing material particles produced during operation of the saw.

### BACKGROUND OF THE INVENTION

1. Field of the Invention

The present invention relates to an electrical hand-held saw, that includes a housing, a saw blade projecting from an end side of the housing and reciprocating along a stroke direction that substantially extends in a direction of a longitudinal extent of the housing limited by the end side.

2. Description of the Prior Art

Electrical hand-held saws of the type described above are known as saber saws, tiger saws, straight back hand saws and, contrary to compass saws in which the stroke direction extends essentially transverse to the longitudinal extent of the saw housing and which are supported against a to-be-sawed workpiece, are held by the user during their operation. In the saws, optionally, a suction device is secured on the housing and have on their end side an opening for removing particles produced during sawing such as dust, chips and the like from the outside.

The suction device serves during operation of the device for aspirating the major portion of the removable material and delivering it to, e.g., a dust collector such as, e.g., industrial dust collectors, in order to prevent excessive accumulation of dirt and dust at a work site. In addition, with an appropriate positioning of the suction opening, a damaging entry of the dust in the saw housing can be prevented.

German publication DE 43 02 674 A1 discloses a stone saw with a suction channel attached to the bottom of the housing. The suction channel has a slot-shaped suction opening located beneath a rear section of a double saw blade. The suction channel is secured to the housing bottom by a hook element and a locking stirrup.

The drawback of this stone saw consists in that the suction channel needs to be adapted to a very large region on the stone saw housing. Further, a portion of the removable material, which is not aspirated through the suction opening, can be relatively large so that a relative high amount of dust and dirt remains on the work site. Further, in spite of the relatively expensive attachment means, only a relatively unstable connection of the suction channel with the stone saw can be obtained and which is easily lost during operation due to tilting or vibration acting on the suction channel.

Accordingly, an object of the present invention to provide an electrical hand-held saw of the type described above in which the drawbacks of the known saw are eliminated and the connection of the suction device to the saw housing is improved.

### SUMMARY OF THE INVENTION

This and other objects of the present invention, which will become apparent hereinafter, are achieved by providing a suction device having a bearing region that directly adjoins the end side of the housing. Thereby, the region of the suction device which should be adapted to the housing, remains relatively small. In addition, the bearing region extends partially along the saw blade, whereby the suction capacity can be noticeably increased.

According to a particularly advantageous embodiment of the invention, the bearing region surrounds the saw blade. Thereby, the suction device forms, at the end side of the saw housing, a suction chamber in which suction of the removable material from all sides of the saw blade occurs which further improves the suction capacity.

Advantageously, the bearing region of the suction device adjoins a rubberized region of the housing that can be formed, e.g., by a collar of the handle that is provided on the housing of the electrical hand-held saw. The rubberized region enables a particularly sealed abutment of the suction device against the housing, which reduces flow losses. In addition, in this way a certain preload between the suction device and the housing is achieved, which ensures a particular stable and backlash-free positioning of the suction device.

Advantageously, the suction device has a hood section that forms the bearing region, and the suction opening is provided on the hood section beneath the bearing region. With a conventional extension of the electrical hand-held saw in a horizontal direction, the suction opening is arranged in a direction of the gravity force beneath the bearing region. Therefore, the suction opening lies in the direction of the gravity force, which increases suction capacity, in particular with regard to heavier material particles.

According to a particularly advantageous embodiment of the invention, the suction device is secured on the end side of the housing by a removable guide, e.g., guide shoe. Thereby, means for securing the guide serve simultaneously for securing the suction device. Thereby, means on the housing of the suction device which are necessary for attachment, can be substantially simplified, which noticeably reduces manufacturing costs.

Advantageously, the guide has guide means and a connection device for mounting the guide means on the housing. The suction device has a receptacle adapted to the connection device. In this way, means for securing the suction device can be particularly simple and can be economically produced.

It is particularly advantageous when the connection device has two rods, and the suction device has two holding elements provided, respectively, with two recesses the shape and size of which at least partially correspond to the shape and size of a corresponding cross-section of the rods. In this way, the suction device can be held on the housing particularly reliably against pivoting.

Advantageously, the suction device has an outer side remote of the housing and which the guide means adjoins. In this way, the suction device is secured between the guide means and the end side of the housing. This ensures a particularly stable positioning of the suction device in the stroke direction of the saw blade.

It is further advantageous when the outer side of the suction device has an outer opening that is closed at least partially, by the guide means. This ensures a particularly uniform transmission of the holding forces from the guide means to the suction device, on the one hand, and on the other hand, a particularly good sealing of the suction chamber of the suction device is achieved. This again increases the suction capacity of the suction device.

The novel features of the present invention which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawing show:

FIG. 1 a side view of an electrical hand-held saw according to the present invention with released suction device and released auxiliary guide;

FIG. 2 a side view of the inventive electrical hand-held saw similar to that of FIG. 1 with the suction device attached.

FIG. 3 a front view of the suction device taken alone in direction III in FIG. 1;

FIG. 4 a front view of the inventive electrical hand-held saw in direction IV in FIG. 2; and

FIG. 5 a longitudinal cross-sectional view along line V-V in FIG. 4.

### DETAILED DESCRIPTION OF THE PREFERRED EMBODIMENT

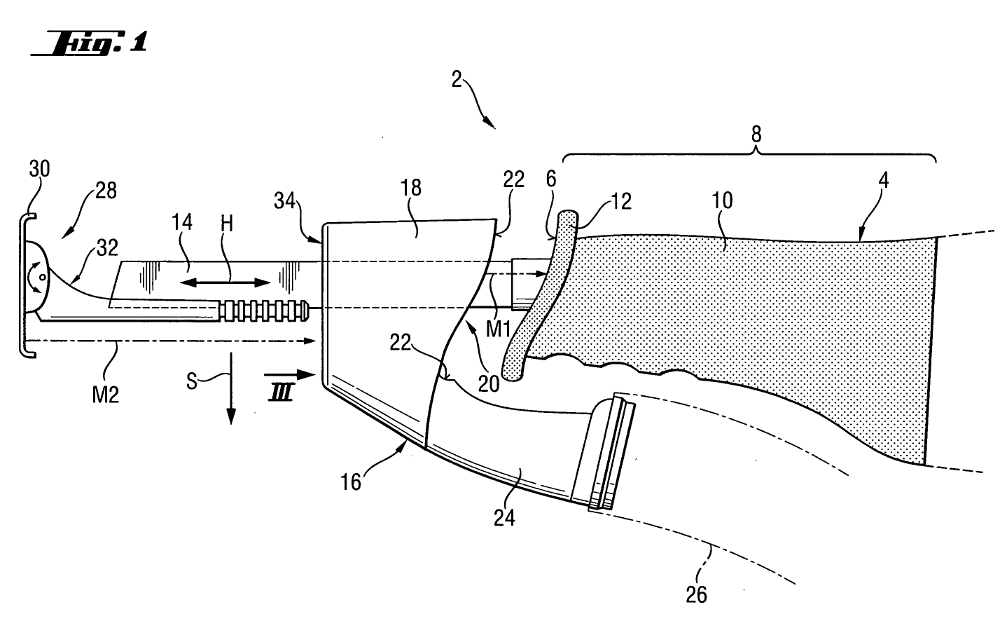

FIG. 1 shows a front portion of an electrical hand-held saw 2 according to the present invention which is formed as a saber saw. The saw 2 has a housing 4 that forms a neck 8 in the direction of an end surface 6 facing in an operational direction. The neck 8 serves as a handle and is provided to this end with a rubber layer 10 on its outer side. The rubber layer 10 forms at the end surface 6 a collar 12 that prevents slipping of a holding hand in the direction of the saw blade 14.

The saw blade 14 projects from the housing neck 8 at the housing end side 6 and reciprocates, along a stroke direction H, substantially parallel to the longitudinal extent of the housing neck 8 and the housing 4 in order to be able to perform a cut in a cutting direction S during the saw operation. For aspiration of the removable material, a suction device 16 is attached to the saw housing 4.

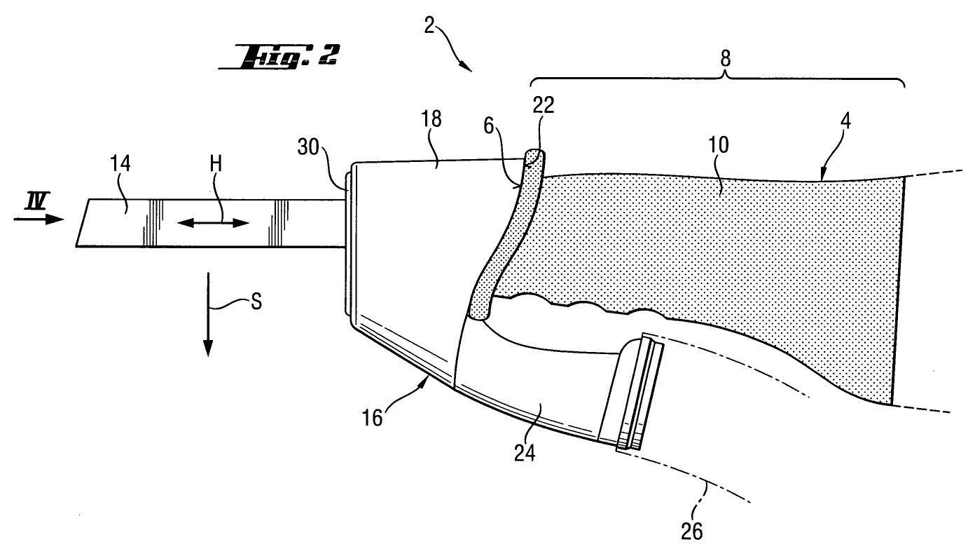

The suction device 16 has a hood section 18 that forms, on the saw side 20, a bearing region 22 that adjoins the end side 6 of the saw housing 4, as shown with a mounting arrow M1 in FIG. 2. The bearing region 22 is adapted to the profile of the end side 6 and surrounds the saw blade 14 when adjoining the end side 6. With reference to a substantially horizontal position of the electrical hand-held saw 2 which is shown in FIGS. 1-2 and which corresponds to a predetermined position during conventional operation, there is provided, beneath the bearing region 22, a connection union 24 to which a suction conduit 26, which connects the suction device 16 with a suction apparatus, e.g., in the form of an industrial dust collector (not shown). is connectable.

For guiding the electrical hand-held saw 2 during the cutting process, there is provided a removable guide 28. The guide 28 has plate-shaped guide means 30 pivotally supported on a connection device 32. The connection device 32 is securable on the housing neck 8, with the guide means 30 adjoining an outer side 34 of the hood section 18, as shown with a mounting arrow M2 in FIG. 2. In this way, the suction device 16 is releasably held on the saw neck 4 by the guide 28.

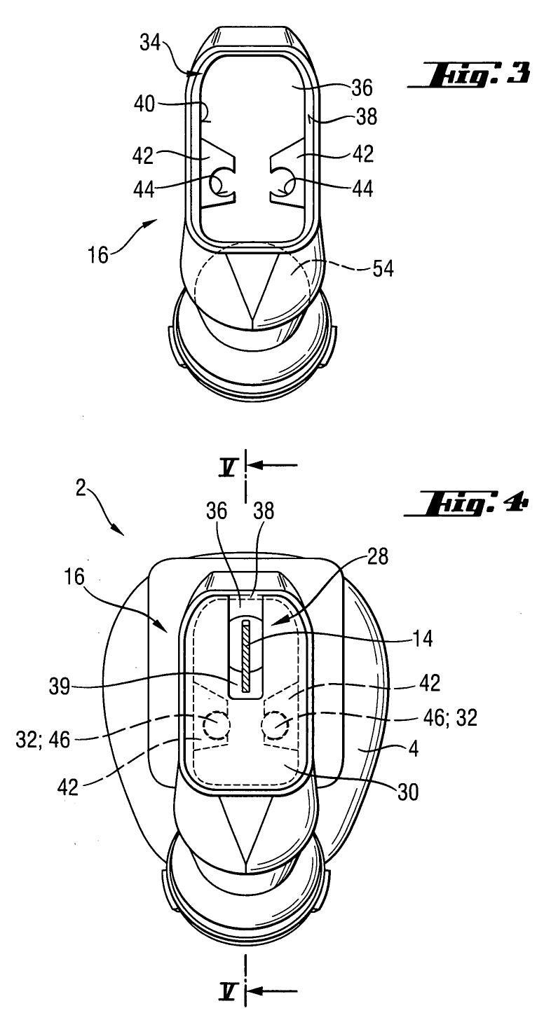

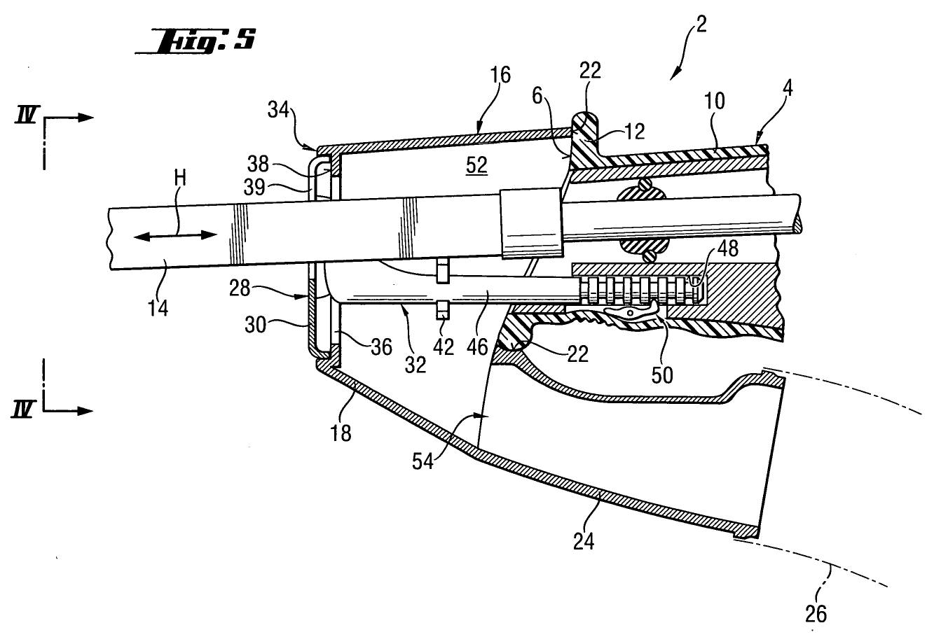

As shown in FIGS. 3-4, the suction device 16 has, on its outer side 34, a suction opening 36 through which the saw blade 14 projects in the completely assembled condition. On the outer opening 36, there is formed a relief-forming receptacle 38, which is adjoined by the guide means 30, as shown in FIGS. 4-5. Thereby the suction device 16 is held by the guide 28 on the housing neck 4 reliably and backlash-free to a most possible extent. Further, in this way, the outer opening 36 up to a through-opening 39 of the guide means 30, through which the saw blade 14 projects from the suction device 16, is closed to a most possible extent.

Two holding elements 42 project inward from an inner side 40 of the hood section 18. The holding elements 42 are provided, respectively, with recesses 44. The recesses 44 are adapted in shape and size to the connection rods 46 having a circular cross-section, as shown in FIG. 4. Thereby, during the assembly, the suction device 16 can first be positioned on the guide 28 to be secured on the housing neck 4 thereby.

As shown in FIG. 5, the two connection rods 46 of the connection device 32 are positioned in the corresponding recesses 48 of the saw housing 4 and are secured with locking means 50. In this position the guide 28, the bearing region 22 is pressed by the guide means 30, at least partially against the rubber layer 10 or the collar 12. In this way, the hood section 18 forms a suction chamber 52 that is sealed relatively well towards the outside. The suction chamber 52 is connected with the suction conduit 26 via a suction opening 54 of the connection union 24, which is located in the bearing region 22. In this way, during an operation, the non-shown dust suction apparatus creates underpressure in the suction chamber 52 via the suction conduit 26. Thereby, the dirt and dust which are carried in the suction chamber 52 by the saw blade 14 is delivered through the suction opening 54 to the suction conduit 26. in addition, the underpressure in the suction chamber 52 provides for suction of dirt and dust through the through-opening 39 from outside.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. An electrical hand-held saw, comprising a housing (4); a saw blade (14) projecting from an end side (6) of the housing (4) and reciprocating along a stroke direction (H) that substantially extends in a direction of a longitudinal extent of the housing (4) limited by the end side (6); a suction device (16) securable on the housing (4) and having a bearing region (22) adjoining the end side (6) of the housing (4) and a suction opening (54) for removing material particles produced during operation of the saw.

2. An electrical hand-held saw according to claim 1, wherein the bearing region (22) surrounds the saw blade (14).

3. An electrical hand-held saw according to claim 2, wherein the housing (4) has a rubberized region (10), and the bearing region (22) of the suction device (16) adjoins the rubberized region (10) of the housing (4).

4. An electrical hand-held saw according to claim 1, wherein the suction device (16) comprises a hood section (18) that forms the bearing region (22), and the suction opening (54) is provided on the hood section (18) beneath the bearing region (22).

5. An electrical hand-held saw according to claim 1, further comprising a removable guide (28), and the suction device (16) is mounted on the end side (6) of the housing (4) by the guide (28).

6. An electrical hand-held saw according to claim 5, wherein the guide (28) has guide means (30) and a connection device (32) for mounting the guide means (30) on the housing (4), and the suction device (16) has a receptacle (38) adapted to the connection device (32).

7. An electrical hand-held saw according to claim 6, wherein the connection device has two rods (46), and the suction device has two holding elements (42) provided, respectively, with two recesses (44) shape and size of which at least partially corresponds to shape and size of a corresponding cross-section of the rods (46).

8. An electrical hand-held saw according to claim 6, wherein the suction device (16) has an outer side (34) remote from the housing (4), and which the guide (28) adjoins.

9. An electrical hand-held saw according to claim 8, wherein the outer side (34) has an outer opening (36), at least partially, by the guide means (30).
